(19) United States
(12) Patent Application Publication
(10) Pub. No.: US 2005/0263501 A1
(43) Pub. Date: Dec. 1, 2005

(54) Laser beam processing method and component machined by the method

(75) Inventors: Tomonari Otsuki, Tokyo (JP); Tatsunobu Umezawa, Tokyo (JP)

Correspondence Address: ABELMAN, FRAYNE & SCWAB, 666 Third Avenue, 10th Floor, New York, NY, 10017, US

(73) Assignees: DDK LTD.; SHINOZAKI MANUFACTURING CO., LTD.

(21) Appl. No.: 11/142,039

(22) Filed: May 31, 2005

(30) Foreign Application Priority Data
Jun. 1, 2004 (JP) 2004-162671

(51) Int. Cl. B23K 26/38

(52) U.S. Cl. 219/121.69

(57) ABSTRACT

In a laser beam machining method, after a transparent film of light permeable material has been attached to a workpiece at least on the laser beam incident side, a laser beam is irradiated onto the workpiece. A transparent film of a light permeable material is attached to the side of the workpiece opposite to the laser beam incident side. The laser beam machining method is utilized to machine components. Even if an inexpensive laser beam is used, the laser beam machining method generates perforations with diameters of less than 20 μm., cuts with widths of less than 20 μm., and readily removes carbon particles attached to the workpiece when being machined.

### BACKGROUND OF THE INVENTION

This invention relates to a laser beam processing method used for perforating and cutting, and more particularly to a laser beam machining method for use in perforating with fine diameters and cutting with fine widths.

A laser beam machining for perforating or cutting has been used by focusing laser beam onto the surface of a workpiece through a lens to concentrate thermal energy at a point of the workpiece as described in the following Patent Literatures 1 to 4.

Japanese Patent Application Opened No. 2003-340,557 (Patent Literature 1) discloses a method for removing surface defects of cast metals by utilizing the laser beam machining. In order to eliminate surface defects to be found in the post-processing steps owing to overlooking the surface defects, this patent literature has proposed a method for removing not only surface defects easily detected on the cast metals but also surface defects which are desired to be removed but are very difficult to be found. In the method, a cast piece 1 is cooled by pouring water thereonto at a temperature immediately before when the cooling temperature of the cast piece 1 in continuous casting becomes below its Ar3 transformation temperature so that the cast piece is cooled at a cooling rate faster than that appearing ferrite and pearite structures. After being cooled, the cast metal 1 is inspected to detect a surface defect having a length L in the detected area A. Then the cast metal 1 is subjected to turning operation to cut off all surface defects 2 of the cast metal 1 including those in an undetected area B extending from the detected area A outwardly in both directions over more than the distance 0.5 L. Thereafter, the cast metal 1 is heated in a heating furnace to a hot rolling temperature and rolled at the temperature to form billets.

Japanese Patent Application Opened No. H11-170,511 (1999) (Patent Literature 2) disclosed another method. This opened application has an object to provide a method for positioning an orifice plate at a laser beam machining position in a simple manner when the orifice plate is formed with orifices, and to provide an ink-jet head and a method for producing the same, which is able to eliminate irregularities in delivery amounts of ink due to irregularities in orifice length. In order to achieve this object, the orifice plate 1 consists of a resin tape 3 and taper members 2 formed thereon. The taper members 2 are formed with taper apertures 4. In reality, the taper members 2 are formed on the resin tape 3 simultaneously and together with a tapered aperture 4 by the insert molding. Under the condition of the plurality of the taper members 2 formed on the resin tape 3, the resin tape 3 being transferred is subjected to laser beam machining to form orifices 5. Thereafter, the taper members 2 and the resin tape 3 are cut off in a manner substantially conforming to ink-jet heads.

Japanese Patent Application Opened No. 2003-33,887 (Patent Literature 3) discloses a further laser beam machining method. This opened application has an object to a provide a method for cutting a workpiece without causing melted portions or cleavage lines leaving the predetermined cutting lines. For this purpose, this method includes steps of fixing a workpiece 1 onto a sheet (film) having an adhesive surface, and irradiating laser beam L to focus at a focus point P in the workpiece 1, thereby forming a modified region in the workpiece 1 along its predetermined cutting line 5.

Japanese Patent Application Opened No. 2003-334,812 (Patent Literature 4) discloses a laser beam machining method. This invention has an object to provide laser beam machining method capable of cutting a workpiece with a high accuracy even if workpieces are a variety of laminated structures. For this purpose, the method includes steps of installing an expansible tape 23 on the rear surface 21 of a flat-shaped wafer 1a having a substrate 15 therein, irradiating laser beam L onto the surface 3 of the wafer 1a as an incident surface to focus at a focal point P in the substrate 15 so that a processed melted region 13 is formed by multiphoton absorption, thereby forming a cutting starting region 8 in the wafer 1a with the aid of the processed melted region 13 along a predetermined cutting line 5 inside the predetermined distance from the laser beam incident surface, and causing the expansible tape 23 to expand to cut the wafer 1a starting from the cutting starting region 8 into a plurality of parts in a manner that the parts are spaced from one another.

In recent years with miniaturization of electric or electronic appliances, the laser beam machining method has been strongly required to be able to form apertures with even finer diameters and cut with even narrower widths. Nowadays, perforating and cutting machining less than 20 μm may be pursued. In the laser beam machining using carbon dioxide laser or YAG high frequency laser, there has been a difficulty when perforating or cutting with a size of less than 20 μm. In the case using laser beam such as excimer laser, the perforating or cutting with the size of less than 20 μm may be possible. However, it suffers from a problem of expense.

In the laser machining, on the other hand, carbon particles produced by carbonization of the material of a workpiece may spatter so as to accumulate on the surface of the workpiece so that additional and troublesome operations as cleaning or wiping are required to remove the accumulated carbon particles.

In the invention of the Patent Literature 2, the orifice plate having the taper apertures is provided on the resin tape by the insert molding, and the laser beam machining is applied to the resin tape, while being conducted by the taper apertures. This invention does not teach or suggest a solution for the above problems.

In the invention of the Patent Literature 3, the laser beam is focused in the workpiece to form a modified region inside it, and the workpiece is cut naturally or by applying a load. The workpiece is fixed to the adhesive sheet (film) in order to prevent chips of the workpiece from spattering when cutting it. It is clear that this invention does not solve the above problems and does not have the feature of focusing the laser beam onto the surface of the workpiece.

In the invention of the Patent Literature 4, the expansible tape is installed onto the rear surface of the workpiece and the laser beam is focused in the workpiece to form a processed melted region therein to cut the workpiece by its expanding force into parts. This invention does not solve the above problems and does not cause the laser beam to focus on the surface of the workpiece.

### SUMMARY OF THE INVENTION

It is an object of the invention to provide an improved laser beam machining method which, in view of the problems of the prior art, is able to do perforating with a diameter of less than 20 μm and cutting with a width of less than 20 μm and to easily remove carbon particles attached to a workpiece when being machined. It is another object of the invention to provide a component machined by the improved laser beam machining method.

The objects of the invention can be achieved by the laser beam machining method according to the invention in which after a film of a light permeable material namely a transparent film has been attached to a workpiece at least on the laser beam incident side, namely inlet side, and the laser beam is irradiated onto the workpiece.

In a preferable embodiment of the invention, the transparent film is further attached to the workpiece on the opposite side of the laser beam incident side, namely outlet side as well. Attached carbon particles can be readily removed by peeling off the films.

As the laser beam for machining, carbon dioxide laser, YAG high frequency laser and the like are used. According to the invention, even if the comparatively inexpensive laser beams such as carbon dioxide laser, YAG high frequency laser and the like are used, it becomes possible to carry out perforating apertures with diameters of less than 20 μm and cutting with widths of less than 20 μm.

In a preferred embodiment of the invention, as the film to be attached, light permeable films such as ultra violet photosensitive dry film, polyethylene film and the like are used.

According to the invention, workpieces having a thickness of 0.025 to 0.5 mm are machined by the method.

In laser beam machining, materials suitable for the method according to the invention are used. A flexible printed circuit board is formed with U-shaped slits by means of the method according to the invention.

As can be seen from the above explanation, the laser beam machining method and the component machined by the method can bring about the following significant effects.

(1) According to the invention, after a film has been attached to a workpiece at least on the laser beam incident side, the laser beam is irradiated onto the workpiece for laser beam machining. Therefore, even if carbon dioxide laser or YAG high frequency laser is used, it is possible to effect perforation with diameters of less than 20 μm and cutting with widths of less than 20 μm.

(2) According to the invention, after a film has been attached to a workpiece at least on the laser beam incident side, the laser beam is irradiated onto the workpiece for laser beam machining. Accordingly, carbon particles which spattered from the workpiece and accumulated thereon can be easily removed only by peeling the film from the workpiece.

(3) According to the invention, a film is further attached to the workpiece on the opposite side of the laser beam incident side as well. Accordingly, carbon particles which spattered from the workpiece and accumulated thereon can be easily removed only by peeling the films from the workpiece.

(4) According to the invention, even if carbon dioxide laser or YAG high frequency laser is used, it is possible to effect perforation with diameters of less than 20 μm and cutting with widths of less than 20 μm.

(5) According to the invention, light permeable films such as ultra violet photosensitive dry film, polyethylene film and the like are used as the film. Therefore, even with an inexpensive laser beam machining using carbon dioxide laser or YAG high frequency laser, it is possible to effect perforation with diameters of less than 20 μm and cutting with widths of less than 20 μm.

(6) Using the laser beam machining method according to the invention, after a film has been attached to a workpiece at least on the laser beam incident side, the laser beam is irradiated onto the workpiece for laser beam machining, making it possible to form U-shaped slits having a width of less than 20 μm in a flexible printed circuit board.

The invention will be more fully understood by referring to the following detailed specification and claims taken in connection with the appended drawings.

### BRIEF DESCRIPTION OF THE DRAWINGS

FIG. 1 is a view for explaining the laser beam machining;

FIG. 2 is a partly plan view of an electrical connector;

FIG. 3 is a view for explaining an optical system for laser beam machining used in an experiment;

FIG. 4 is a view for explaining the experiment; and

FIG. 5 is a graph illustrating the result of Table 1.

### DESCRIPTION OF THE PREFERRED EMBODIMENTS

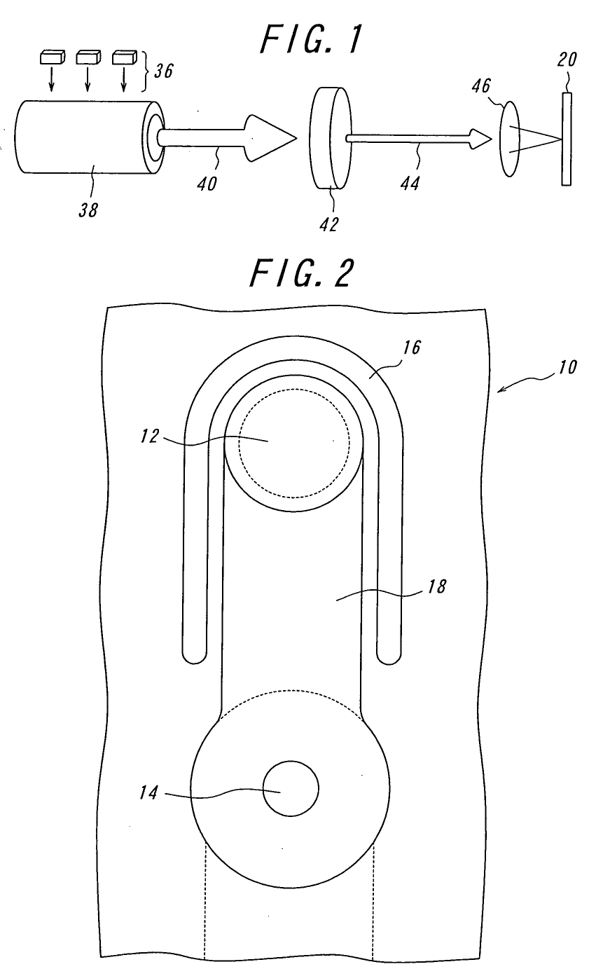

First, the laser beam machining will be explained. As shown in FIG. 1, a YAG rod 38 is excited by laser diodes 36 to produce infrared radiation (λ=1.064 μm) 40 which is irradiated to a nonlinear crystal (wavelength converting element) 42. The radiation passed through the nonlinear crystal becomes ultra violet radiation (λ=0.355 μm) 44 which is focused through a lens 46 at one point on a workpiece 20 where thermal energy is concentrated, whereby machining of the workpiece 20 is possible such as perforating and cutting.

Films to be attached to a workpiece in the method include ultra violet photosensitive dry film, polyethylene film and the like which are light permeable.

One example of components machined by the laser beam machining method according to the invention will be explained. As shown in FIG. 2, there is an electrical connector 10 using a flexible printed circuit board 18 having a plurality of electric contacts 12 and formed with a U-shaped slit 16 around each of the electric contacts 12. The U-shaped slits 16 serve to support the electric contacts 12 by resiliently supporting the respective electric contacts 12 in a cantilevered manner. In order to fully comply with the strong requirement for miniaturization of electrical connectors 10, the pitches between electric contacts should be remarkably narrower. For this purpose, the width of the U-shaped slits 16 must be as narrow as possible. Under the circumstances, the following experiment was carried out using the laser beam machining method according to the invention in order to make the width of the U-shaped slits 16 as small as possible.

First, there were provided flexible printed circuit boards (workpieces) 20 made of polyimide having a thickness of 100 μm. Four kind of ultra violet photosensitive dry films 22 having different thicknesses (20 μm, 30 μm, 38 μm and 50 μm) were attached to the flexible printed circuit boards, respectively. The flexible printed circuit boards without the film were also prepared. As shown in FIG. 4, the flexible printed circuit board 20 has a construction in that a base 24 has polyimide films 28 attached thereto on both surfaces through adhesive layers 26.

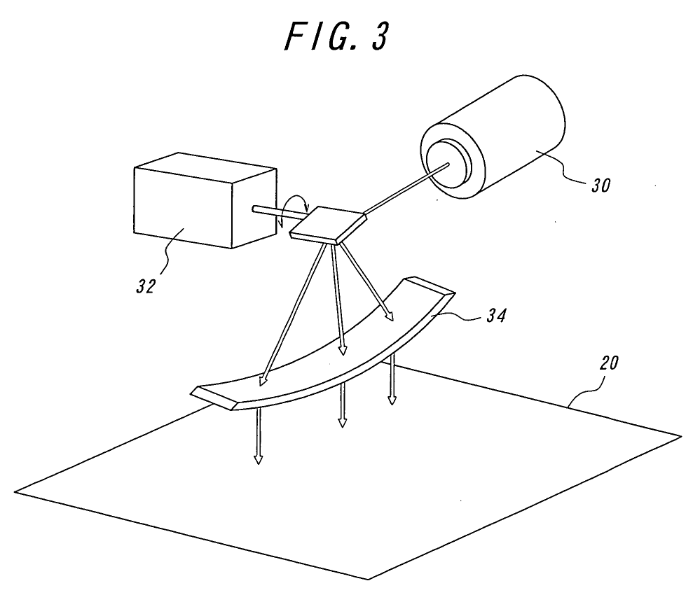

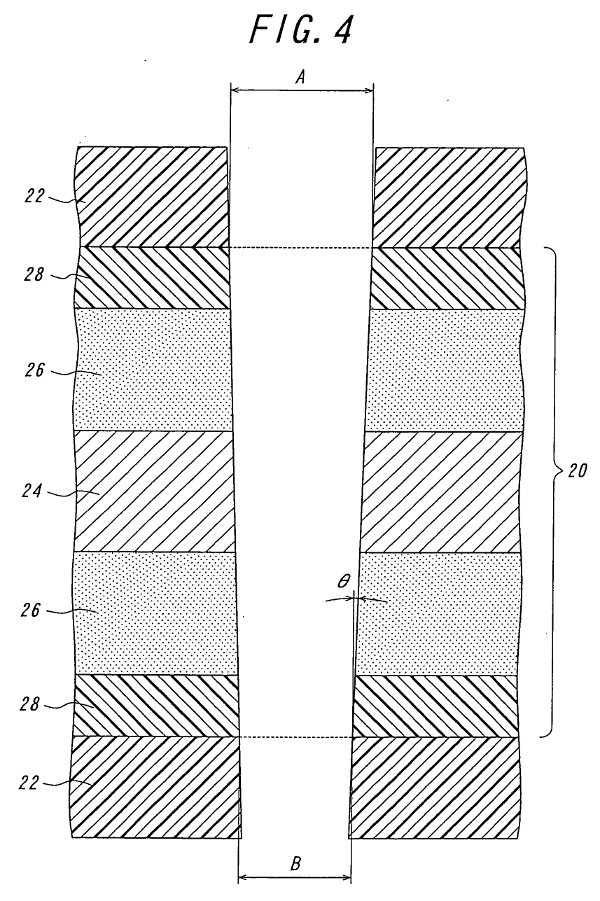

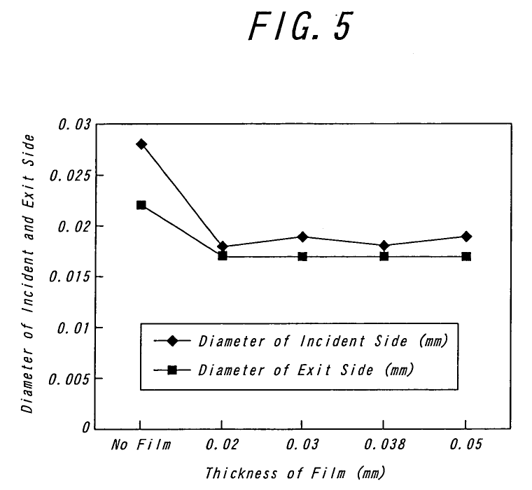

Then, these flexible printed circuit boards were formed with U-shaped slits 16, respectively, as shown in FIG. 2. As an optical system for the experiment, used was an apparatus exclusive to YAG third high frequency laser and mainly employing a reflecting mirror, a laser oscillator or generator 30, a galvanometer 32 and an fθ lens 34 (FIG. 3).

The results of the experiment are shown in Table 1.

TABLE 1

| | | | | | |
|---|---|---|---|---|---|
| Thickness of Film (mm) | No Film | 0.020 | 0.030 | 0.038 | 0.050 |
| Diameter of Incident Side | 0.028 | 0.018 | 0.019 | 0.018 | 0.019 |
| A (mm) | | | | | |
| Diameter of Exit Side | 0.022 | 0.017 | 0.017 | 0.017 | 0.017 |
| B (mm) | | | | | |

As can be seen from Table 1, in the case of the flexible printed circuit boards 20 not having a film 22 attached thereto (the state of the board with the films 22 removed in FIG. 4), the diameter (A) on the side of the laser beam incident side or inlet side differs from and is 6 μm larger than the diameter (B) on the side of the laser beam exit side or outlet side. It means that this aperture (width of the slot) has on its inside a gradient (θ) of approximately 2 degrees.

In contrast herewith, in the case that after the films 22 are attached to the surfaces of the flexible printed circuit board 20 (the state of the board with the films 22 as shown in FIG. 4), the U-shaped slits 16 are formed in the board, regardless of thicknesses of the films 22 differences between the diameters at the inlets and the outlets are only of the order of 1 to 2 μm and gradients (θ) of the apertures are only approximately 0.5 degree. It is clear that by attaching the films 22 to the flexible printed circuit board 20, for example, in the case of the exit side or outlet side, it becomes possible to form the apertures having a diameter 5 μm smaller than that of the case not having the films. In other words, by attaching the films it becomes possible to perforate with diameters of less than 20 μm.

Examples of the application of the present invention are effective laser beam machining for perforating and cutting with high accuracy, particularly perforating with fine diameters and cutting with fine widths.

While the invention has been particularly shown and described with reference to the preferred embodiments thereof, it will be understood by those skilled in the art that the foregoing and other changes in form and details can be made therein without departing from the spirit and scope of the invention.

1. A laser beam processing method, comprising the steps of:
attaching a first transparent film of a light permeable material to at least a laser beam incident side of a workpiece; and
irradiating the workpiece with a laser beam.

2. The laser beam processing method as set forth in claim 1, further comprising the step of:
attaching a second transparent film of the light permeable material to a side of the workpiece opposite the laser beam incident side of the workpiece.

3. The laser beam processing method as set forth in claim 1, wherein a laser generates the laser beam selected from the group of a carbon dioxide laser beam and a yttrium aluminum garnet (YAG) high frequency laser beam.

4. The laser beam processing method as set forth in claim 1, wherein the first light permeable transparent film is selected from the group of an ultra violet photosensitive dry film and a polyethylene film.

5. The laser beam processing method as set forth in claim 1, wherein the workpiece has a thickness in the range of 0.025 mm. to 0.5 mm.

6. A component machined by the use of said laser beam processing method as set forth in claim 1.

7. A flexible printed circuit board having U-shaped slits processed by the use of said laser beam machining method as set forth in claim 1.

8. The laser beam processing method as set forth in claim 2, wherein a laser generates the laser beam selected from the group of a carbon dioxide laser beam and a yttrium aluminum garnet (YAG) high frequency laser beam.

9. The laser beam processing method as set forth in claim 2, wherein the first light permeable transparent film is selected from the group of an ultra violet photosensitive dry film and a polyethylene film.

10. The laser beam processing method as set forth in claim 3, wherein the first light permeable transparent film is selected from the group of an ultra violet photosensitive dry film and a polyethylene film.

11. The laser beam processing method as set forth in claim 8, wherein the first light permeable transparent film is selected from the group of an ultra violet photosensitive dry film and a polyethylene film.

12. The laser beam processing method as set forth in claim 2, wherein the workpiece has a thickness in the range of 0.025 mm. to 0.5 mm.

13. The laser beam processing method as set forth in claim 3, wherein the workpiece has a thickness in the range of 0.025 mm. to 0.5 mm.

14. The laser beam processing method as set forth in claim 8, wherein the workpiece has a thickness in the range of 0.025 mm. to 0.5 mm.

15. The laser beam processing method as set forth in claim 4, wherein the workpiece has a thickness in the range of 0.025 mm. to 0.5 mm.

16. The laser beam processing method as set forth in claim 9, wherein the workpiece has a thickness in the range of 0.025 mm. to 0.5 mm.

17. The laser beam processing method as set forth in claim 10, wherein the workpiece has a thickness in the range of 0.025 mm. to 0.5 mm.

18. The laser beam processing method as set forth in claim 11, wherein the workpiece has a thickness in the range of 0.025 mm. to 0.5 mm.

19. A laser beam processing method comprising the steps of:
attaching a first transparent film of a light permeable material to at least a laser beam inlet side of a workpiece; and
irradiating the workpiece with a laser beam.

20. The laser beam processing method as set forth in claim 19, further comprising the step of:
attaching a second transparent film of a light permeable material to an outlet side of the workpiece opposite the laser beam inlet side of the workpiece.
